(19) United States
(12) Patent Application Publication
(10) Pub. No.: US 2008/0263074 A1
(43) Pub. Date: Oct. 23, 2008

(54) DATA CONVERSION SYSTEM AND METHOD

(76) Inventors: William Paul Bissett, Tampa, FL (US); David D.R. Kohler, Portland, OR (US)

Correspondence Address: HOLLAND & KNIGHT LLP, 10 ST. JAMES AVENUE, 11th Floor, BOSTON, MA, 02116-3889, US

(21) Appl. No.: 12/108,277

(22) Filed: Apr. 23, 2008

Related U.S. Application Data
(60) Provisional application No. 60/913,527, filed on Apr. 23, 2007.

(51) Int. Cl. G06F 17/30

(52) U.S. Cl. 707/101; 707/E17.009

(57) ABSTRACT

A method and computer program product for receiving a first digital content. The first digital content is processed using a content processing algorithm to generate a second digital content. A value is associated with the processing of the first digital content, thus defining a processing fee.

### RELATED APPLICATIONS

This disclosure claims the benefit of U.S. Provisional Patent Application No. 60/913,527, which is entitled SYSTEM FOR MARKETING DIGITAL PRODUCTS and was filed on 23 Apr. 2007, the entire disclosure of which is incorporated by reference.

This disclosure claims priority to U.S. patent application Ser. No. ______, which is entitled DIGITAL EXCHANGE SYSTEM AND METHOD and was filed on 23 Apr. 2008, the entire disclosure of which is incorporated by reference.

This disclosure claims priority to U.S. patent application Ser. No. ______, which is entitled DIGITAL CONTENT MARKETING SYSTEM AND METHOD and was filed on 23 Apr. 2008, the entire disclosure of which is incorporated by reference.

### TECHNICAL FIELD

This disclosure relates to digital conversion process and, more particularly, to digital conversion process that provide access to one or more content processing algorithms.

### BACKGROUND

Various pieces of digital content (e.g., audio, image, video, computer games, geospatial information, etc.) are available in multiple formats. Often, a user has digital content in one format and desires to have it in a different format. Alternatively, a user may have one or more pieces of digital content that when combined in a certain way would produce desired new digital content. The user's options are typically to look for software packages capable of performing the conversion, modification, combination, etc. Software packages capable of performing the processing may be stand-alone software packages that are expensive and/or complex, or they may be software algorithms or subroutines existing as a feature or option of a particular software package. The user's other option is to develop for himself the software capable of performing the desired transformation/modification.

In a first implementation, a method includes receiving a first digital content. The first digital content is processed using a content processing algorithm to generate a second digital content. A value is associated with the processing of the first digital content, thus defining a processing fee.

One or more of the following features may be included. Receiving the first digital content may include receiving the first digital content from a first party. The second digital content may be provided to the first party. The first party may be charged at least a portion of the processing fee. At least a portion of the processing fee may be provided to a second party that developed at least a portion of the content processing algorithm.

Receiving the first digital content may include receiving the first digital content from a data store. A value may be associated with the first digital content, thus defining a first value.

The second digital content may be offered for a final value that is at least the sum of the processing fee and the first value. The second digital content may be sold/licensed to a first party. The second digital content may be provided to the first party. The first party may be charged at least the final value. The second digital content may be sold/licensed to a third party. The second digital content may be provided to the third party. The third party may be charged at least the final value.

At least a portion of the processing fee may be provided to a second party that developed at least a portion of the content processing algorithm. At least a portion of the first value may be provided to an owner of the first digital content.

In another implementation, a computer program product resides on a computer readable medium having a plurality of instructions stored on it. When executed by a processor, the instructions cause the processor to perform operations including receiving a first digital content. The first digital content is processed using a content processing algorithm to generate a second digital content. A value is associated with the processing of the first digital content, thus defining a processing fee.

One or more of the following features may be included. Receiving the first digital content may include receiving the first digital content from a first party. The second digital content may be provided to the first party. The first party may be charged at least a portion of the processing fee. At least a portion of the processing fee may be provided to a second party that developed at least a portion of the content processing algorithm.

Receiving the first digital content may include receiving the first digital content from a data store. A value may be associated with the first digital content, thus defining a first value.

The second digital content may be offered for a final value that is at least the sum of the processing fee and the first value. The second digital content may be sold/licensed to a first party. The second digital content may be provided to the first party. The first party may be charged at least the final value. The second digital content may be sold/licensed to a third party. The second digital content may be provided to the third party. The third party may be charged at least the final value.

At least a portion of the processing fee may be provided to a second party that developed at least a portion of the content processing algorithm. At least a portion of the first value may be provided to an owner of the first digital content.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a digital exchange process and data conversion process coupled to a distributed computing network;

FIG. 2 is a flowchart of the digital exchange process of FIG. 1; and

FIG. 3 is a flowchart of the data conversion process of FIG. 1.

Like reference symbols in the various drawings indicate like elements.

### DETAILED DESCRIPTION OF THE DISCLOSURE

### System Overview:

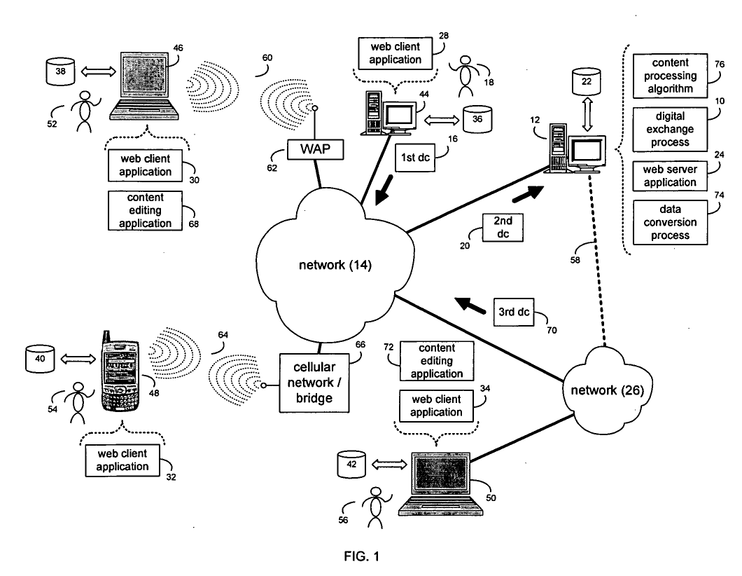

Referring to FIG. 1, there is shown digital exchange process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example.

As will be discussed below in greater detail, digital exchange process 10 may provide a first digital content 16 (e.g., a map) that may be authored by a first party (e.g., user 18). A value (e.g., $100) may be associated with first digital content 16, thus defining a first value at which first digital content 16 is offered. As used in this disclosure, “offered” is intended to include e.g., offering first digital content 16 “for sale” and/or offering first digital content 16 “for license”. A second digital content (e.g., second digital content 20) may be received from a second party that is based, at least in part, on first digital content 16. Second digital content 20 may provide a first enhancement (e.g., a first overlay) to first digital content 16. A value ($50) may be associated with the first enhancement of second digital content 20, thus defining a second value.

The instruction sets and subroutines of digital exchange process 10, which may be stored on storage device 22 coupled to server computer 12, may be executed by one or more processors (not shown) and one or more memory architectures (not shown) incorporated into server computer 12. Storage device 22 may include but is not limited to: a hard disk drive; a tape drive; an optical drive; a RAID array; a random access memory (RAM); and a read-only memory (ROM).

Server computer 12 may execute web server application 24, examples of which may include but are not limited to: Microsoft IIS™, Novell Webserver™, or Apache Webserver™, that allows for HTTP (i.e., HyperText Transfer Protocol) access to server computer 12 via network 14. The instruction sets and subroutines of web server application 24, which may be stored on storage device 22 coupled to server computer 12, may be executed by one or more processors (not shown) and one or more memory architectures (not shown) incorporated into server computer 12.

Network 14 may be connected to one or more secondary networks (e.g., network 26), examples of which may include but are not limited to: a local area network or an intranet, for example. Digital exchange process 10 may be a stand alone application that interfaces with web server application 24 or an applet/application that is executed within web server application 24.

The instruction sets and subroutines of web client applications 28, 30, 32, 34 which may be stored on storage devices 36, 38, 40, 42 (respectively) coupled to client electronic devices 44, 46, 48, 50 (respectively), may be executed by one or more processors (not shown) and one or more memory architectures (not shown) incorporated into client electronic devices 44, 46, 48, 50 (respectively). Storage devices 36, 38, 40, 42 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of web client applications 28, 30, 32, 34 may include Microsoft Internet Explorer™, Apple Safari™, and Mozilla FireFox™.

Examples of computing devices 44, 46, 48, 50 may include, but are not limited to, personal computer 44, laptop computer 46, personal digital assistant 48, notebook computer 50, a data-enabled, cellular telephone (not shown), and a dedicated network device (not shown), for example. Using web client applications 28, 30, 32, 34, users 18, 52, 54, 56 may allow access to one or more applications resident on and served by e.g., server computer 12 and/or web server application 24.

Users 18, 52, 54, 56 may access web server application 24 directly through the device on which the web client application (e.g., web client applications 28, 30, 32, 34) is executed, namely client electronic devices 44, 46, 48, 50, for example. Users 18, 52, 54, 56 may access web server application 24 directly through network 14 or through secondary network 26. Further, server computer 12 (i.e., the computer that executes web server application 24) may be connected to network 14 through secondary network 26, as illustrated with phantom link line 58.

The various client electronic devices may be directly or indirectly coupled to network 14 (or network 26). For example, personal computer 44 is shown directly coupled to network 14 via a hardwired network connection. Further, notebook computer 50 is shown directly coupled to network 26 via a hardwired network connection. Laptop computer 46 is shown wirelessly coupled to network 14 via wireless communication channel 60 established between laptop computer 46 and wireless access point (i.e., WAP) 62, which is shown directly coupled to network 14. WAP 62 may be, for example, an IEEE 802.11a, 802.11b, 802.11g, Wi-Fi, and/or Bluetooth device that is capable of establishing wireless communication channel 60 between laptop computer 46 and WAP 62. Personal digital assistant 48 is shown wirelessly coupled to network 14 via wireless communication channel 64 established between personal digital assistant 48 and cellular network/bridge 66, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 44, 46, 48, 50 may each execute an operating system, examples of which may include but are not limited to Microsoft Windows™, Microsoft Windows CE™, Redhat Linux™, or a custom operating system.

### System Operation:

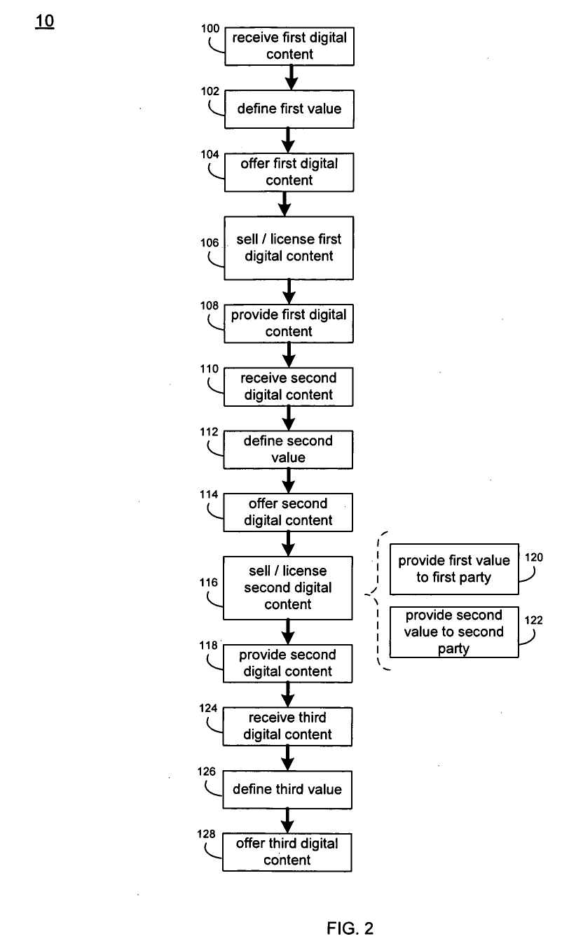

Referring also to FIG. 2 and as discussed above, assume that user 18 is a mapmaker and user 18 generates a map of Tampa Bay, Fla. (e.g. first digital content 16). Assume that user 18 would like to offer first digital content 16 to third parties. As discussed above, this offer may be in the form of e.g. an outright sale, an exclusive license, or a nonexclusive license. Accordingly, user 18 may upload first digital content 16 (from personal computer 44 to server computer 12 via network 14) to digital exchange process 10. Once received 100, digital exchange process 10 may allow user 18 to define 102 a value that may be associated with first digital content 16. As discussed above, assume for illustrative purposes that user 18 defines 102 (via web client application 28) a value of $100 for a nonexclusive license to first digital content 16. Digital exchange process 10 (via web server application 24) may e.g. serve a webpage that offers 104 a nonexclusive license to first digital content 16 for $100.

Further assume for illustrative purposes that a second party (e.g., user 52) is a producer of digital content who browses (via web client application 30) the offerings of digital exchange process 10. Further, assume that user 52 desires to use first digital content 16 as a starting point for making second digital content 20. Continuing with the above stated example, assume for illustrative purposes that user 52 has population density data that user 52 would like to display as an overlay on top of first digital content 16 (i.e. the map of Tampa Bay Fla.). Assuming that user 52 finds the $100 nonexclusive licensing fee to be reasonable, user 52 may effectuate payment of the $100 fee to digital exchange process 10 and digital exchange process 10 may sell/license 106 first digital content 16 to user 52. Once payment is effectuated, digital exchange process 10 may provide 108 first digital content 16 to user 52 (via e.g. network 14 and wireless communication channel 60). For example, digital exchange process 10 may allow user 52 to download a copy of first digital content 16.

At this point in time (or at sometime in the future), digital exchange process 10 may provide remuneration to user 18 with respect to the sale/license of first digital content 16 to user 52. As discussed above, user 18 defined 102 a non-exclusive license to first digital content 16 to have a value of $100. Accordingly, digital exchange process 10 may provide all or a portion of that $100 to user 18. For example, assuming that digital exchange process 10 charges all users with a 10% processing fee, digital exchange process 10 may provide user 18 with remuneration in the amount of $90.

Assume that upon receiving first digital content 16 from digital exchange process 10, user 52 modifies first digital content 16 (using e.g., content editing application 68) to generate second digital content 20. An example of content editing application 68 may include but is not limited to Adobe Photoshop™. The instruction sets and subroutines of content editing application 68, which may be stored on storage device 38 coupled to laptop computer 46, may be executed by one or more processors (not shown) and one or more memory architectures (not shown) incorporated into laptop computer 46. Assume, as discussed above, that user 52 modifies first digital content 16 to include the above-described population density data overlay.

Assume for illustrative purposes that, upon modifying first digital content 16 to generate second digital content 20, user 52 would like to offer second digital content 20 to third parties. As with first digital content 16, the offer of second digital content 20 may be in the form of e.g. an outright sale, an exclusive license, or a nonexclusive license. Accordingly, user 52 may upload second digital content 20 (from laptop computer 46 to server computer 12 via wireless communication channel 60 and network 14) to digital exchange process 10.

While related to first digital content 16, second digital content 20 provides a first enhancement (e.g., the above-described population density data overlay) to first digital content 16. Once second digital content 20 is received 110 from user 52, digital exchange process 10 may allow user 52 to define 112 a second value that is representative of the value of the first enhancement (e.g., the above-described population density data overlay) included within second digital content 20. As discussed above, assume for illustrative purposes that user 52 defines 112 (via web client application 30) a value of $50 for a nonexclusive license to the first enhancement (e.g., the above-described population density data overlay) included within second digital content 20. Accordingly, digital exchange process 10 (via web server application 24) may e.g. serve a webpage that offers 114 a nonexclusive license to second digital content 20 for $150 (i.e., the sum of the $100 nonexclusive licensing fee for first digital content 16 and the $50 nonexclusive licensing fee for the above-described population density data overlay).

Further assume for illustrative purposes that a third party (e.g., user 56) is also a producer of digital content who browses (via web client application 34) the offerings of digital exchange process 10. Further, assume that user 56 desires to use second digital content 20 as a starting point for making third digital content 70. Continuing with the above stated example, assume for illustrative purposes that user 56 has income data that user 56 would like to display as an overlay on top of second digital content 20 (i.e. the map of Tampa Bay, Fla. that includes the population density data overlay). Assuming that user 56 finds the $150 nonexclusive licensing fee to be reasonable, user 56 may effectuate payment of the $150 fee to digital exchange process 10 and digital exchange process 10 may sell/license 116 second digital content 20 to user 56. Once payment is effectuated, digital exchange process 10 may provide 118 second digital content 20 to user 56 (via e.g. network 14 and network 26). For example, digital exchange process 10 may allow user 56 to download a copy of second digital content 20.

At this point in time (or at sometime in the future), digital exchange process 10 may provide remuneration to users 18, 52 with respect to the sale/license of second digital content 20 to user 56. As discussed above, user 18 defined 102 a non-exclusive license to first digital content 16 (included within second digital content 20) to have a value of $100. Further and as discussed above, user 52 defined 112 a non-exclusive license to the first enhancement (e.g., the above-described population density data overlay) included within second digital content 20 to have a value of $50. Accordingly, digital exchange process 10 may provide 120, 122 all or a portion of that $100 to user 18 and all or a portion of that $50 to user 52. For example, assuming that digital exchange process 10 charges all users with a 10% processing fee, digital exchange process 10 may provide 120 user 18 with remuneration in the amount of $90 and may provide 122 user 52 with remuneration in the amount of $45.

Assume that upon receiving second digital content 20 from digital exchange process 10, user 56 modifies second digital content 20 (using e.g., content editing application 72) to generate the third digital content 70. Again, an example of content editing application 72 may include but is not limited to Adobe Photoshop™. The instruction sets and subroutines of content editing application 72, which may be stored on storage device 42 coupled to notebook computer 50, may be executed by one or more processors (not shown) and one or more memory architectures (not shown) incorporated into notebook computer 50. Assume, as discussed above, that user 56 modifies second digital content 20 to include the above-described income data overlay.

Assume for illustrative purposes that, upon modifying second digital content 20 to generate the third digital content 70, user 56 would like to offer third digital content 70 to third parties. As with first digital content 16 and second digital content 20, the offer of third digital content 70 may be in the form of e.g. an outright sale, an exclusive license, or a nonexclusive license. Accordingly, user 56 may upload third digital content 70 (from notebook computer 50 to server computer 12 via network 26 and network 14) to digital exchange process 10.

While related to second digital content 20, third digital content 70 provides a second enhancement (e.g., the above-described income data overlay) to second digital content 20 (which included a first enhancement (i.e., the above-described population density data) to first digital data 16). Once third digital content 70 is received 124 from user 56, digital exchange process 10 may allow user 56 to define 126 a third value that is representative of the value of the second enhancement (e.g., the above-described income data overlay) included within third digital content 70. As discussed above, assume for illustrative purposes that user 56 defines 126 (via web client application 34) a value of $75 for a nonexclusive license to the second enhancement (e.g., the above-described income data overlay) included within third digital content 70. Accordingly, digital exchange process 10 (via web server application 24) may e.g. serve a webpage that offers 128 a nonexclusive license to third digital content 70 for $225 (i.e., the sum of the $100 nonexclusive licensing fee for the first digital content 16, the $50 nonexclusive licensing fee for the above-described population density data overlay, and the $75 nonexclusive licensing fee for the above-described income data overlay).

While user 18 and user 52 are described above as being separate individuals, this is for illustrative purposes only and is not intended to be a limitation of this disclosure. For example, a single individual may offer for license two different versions of a map of Tampa Bay, Fla.; one which includes population density data (for a licensing fee of $150) and one which does not include population density data (for a licensing fee of $100).

While digital exchange process 10 is described above as offering 104 first digital content 16, which is modified by user 52 to generate second digital content 20, which is offered 114 to and modified by user 56 to generate third digital content 70, this is for illustrative purposes only and is not intended to be a limitation of this disclosure. For example, this iterative modification process may be repeated indefinitely and/or as long as market forces dictate.

While first digital content 16 is described above as being map-based data and second/third digital content 20, 70 are described above as being map overlay data, this is for illustrative purposes only and is not intended to be a limitation of this disclosure. For example, first digital content 16 may be a piece of software, and second/third digital content 20, 70 may be complementary software objects operable within first digital content 16. Accordingly, digital content, as used in this disclosure, is intended to include any and all digitized content, examples of which may include but are not limited to: digital audio, digital video, graphical files, document files, and software objects and applications.

While digital exchange process 10 is described above as allowing a user to download a first piece of digital content from digital exchange process 10, modify the first piece of digital content on their local computer (e.g., laptop computer 46) to generate a second piece of digital content, and upload the second piece of digital content to digital exchange process 10, other configurations are possible and are considered to be within the scope of this disclosure.

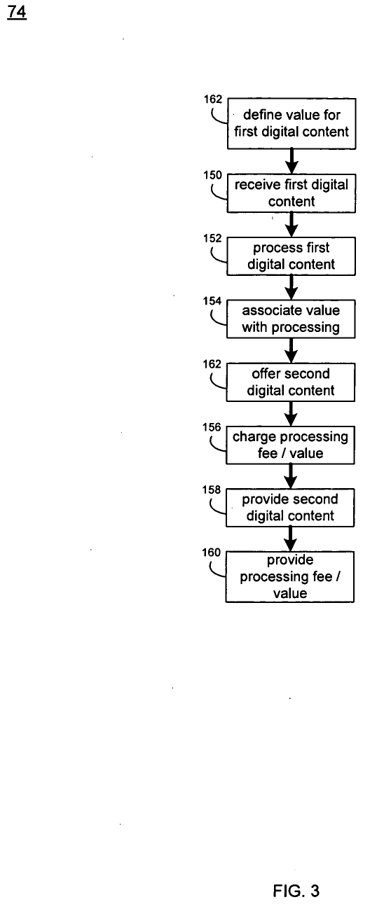

For example and referring also to FIG. 3, there is shown data conversion process 74. As will be discussed below in greater detail, data conversion process 74 may receive a first digital content (e.g., first digital content 16). First digital content 16 may be processed using a content processing algorithm (e.g., algorithm 76) to generate a second digital content (e.g., second digital content 20). A value may be associated with the processing of first digital content 16, thus defining a processing fee.

Data conversion process 74 may be a stand alone application that interfaces with digital exchange process 10 or an applet/application that is executed within digital exchange process 10. The instruction sets and subroutines of data conversion process 74, which may be stored on storage device 22 coupled to server computer 12, may be executed by one or more processors (not shown) and one or more memory architectures (not shown) incorporated into server computer 12.

Assume for illustrative purposes that first digital content 16 was authored by a first party (e.g., user 18). Assume for this example that first digital content 16 is a “noisy” audio recording that was authored by user 18. Further assume that while noise reduction software is available that can process first digital content 16 to remove the “noise”, this software is prohibitively expensive and/or personal computer 44 is not powerful enough to execute the noise reduction software. Further, assume that a noise reduction algorithm (e.g., algorithm 76) is available for execution via server computer 12.

Specifically, users of data conversion process 74 may utilize content processing algorithm 76 to process one or more files that e.g., user 18 either uploads to server computer 12 or obtains from digital exchange process 10. Data conversion process 74 may be configured to charge a processing fee for processing a piece of digital content. Examples of the fee charged may include but are not limited to a flat fee, a fee based upon file size, and a fee based upon processing time. Assume for illustrative purposes that data conversion process 74 is configured to charge a user a flat fee of $10 for processing a single piece of digital content (e.g., first digital content 16.

Assuming that user 18 finds the $10 processing fee to be reasonable, user 18 may upload (e.g., via network 14) first digital content 16 to server computer 12 for processing by data conversion process 74. Upon receiving 150 first digital content 16 from user 18, data conversion process 74 may process 152 first digital content 16 using content processing algorithm 76 to generate second digital content (e.g., second digital content 20). As, in this example, first digital content 16 is a “noisy” audio recording and content processing algorithm 76 is a noise reduction algorithm, second digital content 20 may be a “less-noisy” audio recording.

Data conversion process 74 may associate 154 a value with the processing of first digital content 16. As discussed above and for this particular example, data conversion process 74 defined a processing fee of $10 (the value associated 154 with processing first digital content 16 to generate second digital content 20). Once processed 152, data conversion process 74 may charge 156 e.g., user 18 at least a portion of the above-described processing fee. Assume for illustrative purposes that data conversion process 74 charges 156 user 18 the entire $10 processing fee. User 18 may effectuate payment of the $10 processing fee and data conversion process 74 may provide 158 second digital content 20 to user 18 (e.g., via network 14).

Upon collecting the $10 processing fee, data conversion process 74 may provide 160 at least a portion of the processing fee to a second party (e.g., user 54), who is the user that developed at least a portion of content processing algorithm 76. For example, data conversion process 74 may allow users to write algorithms (e.g., content processing algorithm 76) and make them available for use by third parties for a fee (e.g., the $10 processing fee). Accordingly, data conversion process 74 may provide 160 all or a portion of that $10 fee to user 54. For example, assuming that data conversion process 74 charges all users with a 10% hosting fee, data conversion process 74 may provide user 54 with remuneration in the amount of $9.

Assume for illustrative purposes that in addition to processing 152 first digital content 16, user 18 also would like to offer first digital content 16 to third parties. This offer may be in the form of e.g. an outright sale, an exclusive license, or a nonexclusive license. Accordingly, once first digital content 16 is received 150, data conversion process 74 and/or digital exchange process 10 may allow user 18 to define 162 a value that may be associated with first digital content 16. Assume for illustrative purposes that user 18 defines 162 (via web client application 28) a value of $200 for a nonexclusive license to first digital content 16. Data conversion process 74 and/or digital exchange process 10 (via web server application 24) may e.g. serve a webpage that offers a nonexclusive license to first digital content 16 for $200.

Assume for illustrative purposes that user 52 is a collector of digital content who browses (via web client application 30) the offerings of data conversion process 74 and/or digital exchange process 10. Further, assume that user 52 is interested in obtaining a “less-noisy” version of first digital content 16 (i.e., a “noisy” audio recording). Data conversion process 74 may offer 162 the “less-noisy” version of first digital content 16 for a final value that is at least the sum of the $10 processing fee and the $200 nonexclusive licensing fee.

Assuming that user 52 finds the $200 nonexclusive licensing fee (for first digital content 16) and the $10 processing fee (for processing first digital content 16 using content processing algorithm 76) to be reasonable, data conversion process 74 may receive 150 a copy of first digital content 16 (e.g., from digital exchange process 10) and may process 152 (using algorithm 76) first digital content 16 to generate second digital content 20 (i.e., the “less-noisy” version of first digital content 16 desired by user 52).

Once received 150 and processed 152, data conversion process 74 may charge 156 e.g., user 52 at least a portion of the above-described $10 processing fee and the above-described $200 non-exclusive licensing fee. Assume for illustrative purposes that data conversion process 74 charges 156 user 52 the entire $10 processing fee and the entire $200 non-exclusive licensing fee. Once user 52 effectuates payment of the $10 processing fee and the $200 non-exclusive licensing fee, data conversion process 74 may provide 158 second digital content 20 to user 52 (e.g., via network 14 and wireless channel 60).

Upon collecting the $10 processing fee and the $200 non-exclusive licensing fee, data conversion process 74 may provide 160 at least a portion of the processing fee to user 54 (i.e., the user that developed at least a portion of content processing algorithm 76) and user 18 who is the author of first digital content 16 (i.e., the “noisy” audio recording). For example, assuming that data conversion process 74 charges all users with a 10% hosting fee, data conversion process 74 may provide user 54 with remuneration in the amount of $9 and user 18 with remuneration in the amount of $180.

Assume for illustrative purposes that user 52 would like to offer second digital content 20 to third parties. As with first digital content 16, this offer may be in the form of e.g. an outright sale, an exclusive license, or a nonexclusive license. Accordingly, user 52 may upload second digital content 52 to data conversion process 74 and/or digital exchange process 10. Once second digital content 20 is received, data conversion process 74 and/or digital exchange process 10 may allow user 52 to define a value that may be associated with second digital content 20. Assume for illustrative purposes that user 52 defines (via web client application 30) a value of $250 for a nonexclusive license to second digital content 20. Data conversion process 74 and/or digital exchange process 10 (via web server application 24) may e.g. serve a webpage that offers a nonexclusive license to second digital content 20 for $250. This iterative modification/offering process may be repeated indefinitely and/or as long as market forces dictate.

A number of implementations have been described. Nevertheless, it will be understood that various modifications may be made. Accordingly, other implementations are within the scope of the following claims.

What is claimed is:

1. A method comprising:
receiving a first digital content;
processing the first digital content using a content processing algorithm to generate a second digital content; and
associating a value with the processing of the first digital content, thus defining a processing fee.

2. The method of claim 1 wherein receiving the first digital content includes receiving the first digital content from a first party, the method further comprising:
providing the second digital content to the first party.

3. The method of claim 2 further comprising:
charging the first party at least a portion of the processing fee.

4. The method of claim 3 further comprising:
providing at least a portion of the processing fee to a second party that developed at least a portion of the content processing algorithm.

5. The method of claim 1 wherein receiving the first digital content includes receiving the first digital content from a data store, the method further comprising:
associating a value with the first digital content, thus defining a first value.

6. The method of claim 5 further comprising:
offering the second digital content for a final value that is at least the sum of the processing fee and the first value.

7. The method of claim 6 further comprising:
selling/licensing the second digital content to a first party;
providing the second digital content to the first party; and
charging the first party at least the final value.

8. The method of claim 6 further comprising:
selling/licensing the second digital content to a third party;
providing the second digital content to the third party; and
charging the third party at least the final value.

9. The method of claim 6 further comprising:
providing at least a portion of the processing fee to a second party that developed at least a portion of the content processing algorithm.

10. The method of claim 6 further comprising:
providing at least a portion of the first value to an owner of the first digital content.

11. A computer program product residing on a computer readable medium having a plurality of instructions stored thereon which, when executed by a processor, cause the processor to perform operations comprising:
receiving a first digital content;
processing the first digital content using a content processing algorithm to generate a second digital content; and
associating a value with the processing of the first digital content, thus defining a processing fee.

12. The computer program product of claim 11 wherein the instructions for receiving the first digital content include instructions for receiving the first digital content from a first party, the computer program product further comprising instructions for:
providing the second digital content to the first party.

13. The computer program product of claim 12 further comprising instructions for:
charging the first party at least a portion of the processing fee.

14. The computer program product of claim 13 further comprising instructions for:
providing at least a portion of the processing fee to a second party that developed at least a portion of the content processing algorithm.

15. The computer program product of claim 11 wherein the instructions for receiving the first digital content include instructions for receiving the first digital content from a data store, the computer program product further comprising instructions for:
associating a value with the first digital content, thus defining a first value.

16. The computer program product of claim 15 further comprising instructions for:
offering the second digital content for a final value that is at least the sum of the processing fee and the first value.

17. The computer program product of claim 16 further comprising instructions for:
selling/licensing the second digital content to a first party;
providing the second digital content to the first party; and
charging the first party at least the final value.

18. The computer program product of claim 16 further comprising instructions for:
selling/licensing the second digital content to a third party;
providing the second digital content to the third party; and
charging the third party at least the final value.

19. The computer program product of claim 16 further comprising instructions for:
providing at least a portion of the processing fee to a second party that developed at least a portion of the content processing algorithm.

20. The computer program product of claim 16 further comprising instructions for:
providing at least a portion of the first value to an owner of the first digital content.
